(19) United States
(12) Patent Application Publication
(10) Pub. No.: US 2006/0151268 A1
(43) Pub. Date: Jul. 13, 2006

(54) Copper-free non-asbestos organic friction material

(76) Inventors: Sunil Kesavan, Farmington Hills, MI (US); Xinming Shao, Rochester Hills, MI (US)

Correspondence Address: HARNESS, DICKEY & PIERCE, P.L.C., P.O. BOX 828, BLOOMFIELD HILLS, MI, 48303, US

(21) Appl. No.: 11/034,212

(22) Filed: Jan. 12, 2005

(51) Int. Cl. F16D 69/00

(52) U.S. Cl. 188/251 A

(57) ABSTRACT

A braking element generally including a friction material having one of iron fibers, aluminum, zinc, tin and combinations thereof. An amount of the iron fibers in the friction material is in a range between about 1 v % to about 10 v %. An amount of one of the aluminum, the zinc, the tin and the combinations thereof is in a range between about 1 v % to about 5 v %. The friction material is free of elemental copper. As the friction material wears, elemental copper is not released into the environment.

### FIELD OF THE INVENTION

The present invention relates to a friction material, and more particularly relates to a non-asbestos organic friction material devoid of copper.

### BACKGROUND OF THE INVENTION

Friction materials are typically employed to convert kinetic energy of a moving vehicle or a machine part into heat to slow the movement of the vehicle or the machine part. Typically, the friction material absorbs the heat and gradually dissipates it into the atmosphere. The friction material is converted into wear debris during brake use and can be considered the expendable portion of a brake system.

The brake system must satisfy a certain set of consumer expectations, such as comfort, durability, and reasonable cost. These expectations are translated into a set of specific requirements for the brake system such as a high and stable friction coefficient, vibration and noise characteristics within a predetermined limit, and low wear rates for the friction material and a rotor, a drum or a clutch mating surface. All of the aforesaid requirements have to be achieved simultaneously at a reasonable cost. Particularly, the performance has to be stable under varying application conditions, over extremes in temperature, humidity, speed, and deceleration rates.

While the brake system must satisfy consumer expectations, the brake system must also satisfy domestic and/or international regulations. Future legislation in various countries may be concerned with reduction of copper levels in the environment. One such contributor of copper can be the wear debris from the traditional friction materials.

### SUMMARY OF THE INVENTION

A braking element generally including a friction material having one of iron fibers, aluminum, zinc, tin and combinations thereof. An amount of the iron fibers in the friction material is in a range between about 1 v % to about 10 v %. An amount of one of the aluminum, the zinc, the tin and the combinations thereof is in a range between about 1 v % to about 5 v %. The friction material is free of elemental copper.

Further areas of applicability of the present invention will become apparent from the drawings, the appended claims and below provided detailed description. It should be understood that the detailed description and specific examples, while indicating the various embodiments of the invention, are intended for purposes of illustration and example only and are not intended to limit the scope of the invention.

### BRIEF DESCRIPTION OF THE DRAWINGS

The present invention will become more fully understood from the detailed description, the appended claims and the accompanying drawings, wherein:

FIG. 1 is a cross-sectional view of a disc brake system.

### DETAILED DESCRIPTION OF THE VARIOUS EMBODIMENTS

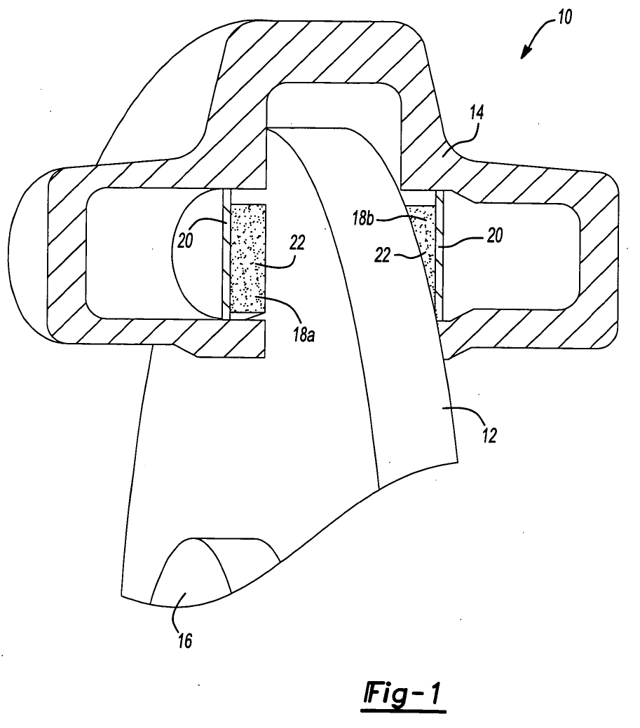

In FIG. 1, the present invention is shown with reference to a simplified and exemplary vehicle disc brake system 10. The disc brake system 10 includes a rotor 12, a caliper 14, and a hub 16. The disc brake system 10 also includes a pair of outboard and inboard brake elements 18a and 18b, respectively, referred to hereinafter as brake elements 18 or brake pads 18. The brake elements 18 mount to the caliper 14 in a manner known in the art. It will be appreciated that the brake system 10 is shown in a simplified fashion. As such, a more detailed explanation of an exemplary disc brake system is shown in commonly assigned U.S. Pat. No. 4,351,421, which is hereby incorporated by reference in its entirety as if fully set forth herein.

Each of the brake elements 18 includes a structural backing 20 and a friction material 22. The friction material 22 mounts to the structural backing 20 using mechanical fasteners and/or chemical bonding (not shown). An example of one such mounting method is disclosed in commonly assigned U.S. Pat. No. 5,073,099, which is hereby incorporated by reference in its entirety as if fully set forth herein.

The brake elements 18 squeeze against rotor 12 to slow the rotation of the rotor 12 to thereby slow the vehicle (not shown) to a desired speed. As noted above, friction is produced when the brake elements 18 come into contact with the rotor 12; this in turn, causes the brake elements 18 to heat and ultimately wear. It will be appreciated that the above description is also applicable to a drum brake configuration, a clutch lining configuration and other non-vehicle configurations, for example, slowing machine parts.

The friction material 22 can be comprised of various suitable materials that may be combined in a slurry form, for example, and pressed and/or molded into a desired shape. The friction material 22 can include iron fibers, aluminum, zinc, tin and/or combination thereof in relatively greater amounts by volume when compared to traditional friction materials. Notwithstanding other friction material components, the friction material 22 is devoid of elemental copper. Aluminum, zinc and/or tin in fiber and/or powder form may be included in a composition of the friction material 22 in combination or in lieu of the iron fibers as a percentage of volume,

Exemplary formulations of the friction material 22 are free of elemental copper and may still provide performance and durability that is comparable to the traditional non-asbestos organic friction materials that contain copper. The exemplary formulations also provide an environmentally advantageous composition of the friction material 22 by being free of elemental copper and increasing the percentage by volume of iron fibers, aluminum, zinc, tin and/or combinations thereof. It will be appreciated that a sufficient amount of elemental copper may be used in the traditional friction material for purposes that include heat dissipation. Accordingly, it will be understood that the present invention may include an increased amount of the iron fibers, aluminum, zinc, tin, and/or combinations thereof to provide comparable functionality when compared to the traditional friction material having the elemental copper as a component of the friction material.

In one embodiment of the present invention, the friction material 22 includes about 1 percent by volume (v %) to about 10 v % of the iron fibers and free of elemental copper. More preferably, the present invention includes 2.5 v % of the iron fibers and is similarly devoid of elemental copper. The preferred percentage of the irons fibers and/or other components of the friction material 22, which are discussed later, provides optimal performance characteristics. It will be appreciated that adherence to the exact percentage of total volume per component is not required to maintain operability of the invention, but the deviation from the exact percentages may reduce performance of the friction material 22.

In other embodiments of the present invention, a length of the iron fibers can be in range of about one-quarter inch (about 0.64 mm) to about one-half inch (about 1.3 mm). The width of the iron fibers can be about 20 micrometers. By way of example, a length to width ratio of the iron fibers can be in a range between about 8 to 1 to about 65 to 1. It will be appreciated that adherence to the exact dimensions of the iron fibers is not required to maintain operability of the invention, but the deviation from the dimensions may reduce performance of the friction material 22. The iron fibers are commercially available from many vendors. One such exemplary supplier is Sunny Metal Inc. (Guangzhou, China)

In other embodiments of the present invention, the friction material 22 can contain, in addition to or in lieu of the above-described iron fibers, about 1 v % to about 5 v % of aluminum, zinc, tin and/or combinations thereof. More preferably, the present invention includes 1 v % of aluminum, zinc, tin and/or combinations thereof. The aluminum, zinc and/or tin may be added in a fiber and/or powder form. A length of the aluminum, zinc and/or tin fibers can be in range between about one-quarter inch (about 0.64 mm) and about one-half inch (about 1.3 mm). The width of the aluminum, zinc and/or tin fibers can be in a range between about 20 micrometers and 80 micrometers. In powder form, the aluminum, zinc and/or tin powder can have a nominal diameter of about 0.05 inches (about 1.5 millimeters or about 10 mesh). It will be appreciated that the aluminum, zinc and/or tin fibers and/or powder are commercially available from many vendors.

In other embodiments of the present invention, the friction material 22 includes about 4.5 v % of the iron fibers and is free of elemental copper. In another embodiment, the friction material 22 includes about 1 v % of the iron fibers and is substantially free of copper. In these embodiments, the iron fibers may be a pure iron fiber, such that the iron fibers are free of any carbon content. In these embodiments, the aluminum, zinc, tin and/or combinations thereof may be added in a fiber and/or powder form to the friction material 22 as above described. It will be appreciated that in the various embodiments of the present invention that iron fibers, aluminum, zinc, and/or tin may be used singularly or in combination with one another and may serve as a replacement for elemental copper.

Table 1 shows ranges of a first exemplary composition of the friction material 22 illustrating another embodiment of present invention. The values found in the column labeled “Exemplary Values” represent preferred valves of the components within the friction material 22.

TABLE 1

| | Exemplary Values |
|---|---|
| Exemplary Components of | (percentage of |
| the Friction Material | total volume) |
| Phenolic Resin | about 20 |
| Rubber Dust | about 8 |
| Cashew Nut Shell Friction Dust | about 15 |
| Coke and/or Graphite | about 11 |
| Alumina | about 3 |
| Magnesium Oxide | about 4 |
| Antimony Sulfide | about 4 |
| Barytes | about 18 |
| Aramid Pulp | about 6 |
| Tin Powder | about 2 |
| Aluminum Fiber | about 3 |
| Iron Fiber | about 3 |
| Mineral Fiber | about 3 |

Table 2 shows ranges of a second exemplary composition of the friction material 22 illustrating another embodiment of present invention. The values found in the column labeled “Exemplary Values” represents exemplary values for the friction material. It will be appreciated that the values outlined above in Table 1 and below in Table 2 are exemplary values and, as such, do not limit the scope of the present invention.

TABLE 2

| | Example Values |
|---|---|
| Components of the | (percentage of |
| Friction Material | total volume) |
| Phenolic Resin | about 19 |
| Rubber Dust | about 8 |
| Cashew Nut Shell Friction Dust | about 12 |
| Graphite | about 6 |
| Synthetic Graphite Petroleum Coke | about 4 |
| Magnetite Powder | about 4 |
| Zirconia | about 5 |
| Antimony Sulfide | about 4 |
| Molybdenum Disulfide | about 3 |
| Barytes | about 18 |
| Aramid Pulp | about 6 |
| Aluminum Powder | about 3 |
| Zinc Fiber | about 3 |
| Mineral Fiber | about 5 |

It will be appreciated that many vendors supply multiple commercially available mineral fibers suitable for use in the friction material 22. In the various embodiments of the present invention, one such exemplary mineral fiber is a Lapinus® Fiber, which is commercially available from Lapinus Fibres B. V. (Netherlands).

It will be appreciated that many vendors supply multiple commercially available metal sulfides and/or metal oxides suitable for use in the friction material 22. In the various embodiments of the present invention, exemplary metal sulfides include antimony sulfide, stannic sulfide, molybdenum disulfide and tin sulfide all of which are commercially available from various vendors.

It will be appreciated that many vendors supply multiple commercially available forms of the rubber dust, the cashew nut friction dust, the aluminum fiber and/or powder, tin fiber and/or powder and zinc fiber and/or powder for use in the friction material 22. In the various embodiments of the present invention, the above components are commercially available from various vendors.

It will be appreciated that many vendors supply multiple commercially available forms of zirconia for use in the friction material 22. In the various embodiments of the present invention, one such exemplary source for suitable commercially available zirconia is Morgan Technical Ceramics (Fairfield, N.J.).

It will be appreciated that many vendors supply multiple commercially available forms of magnetite powder for use in the friction material 22. In the various embodiments of the present invention, one such exemplary source for suitable commercially available magnetite powder is Reade Advanced Materials (Pawtucket, R.I.).

It will be appreciated that many vendors supply multiple commercially available forms of alumina for use in the friction material 22. In the various embodiments of the present invention, one such exemplary source for suitable commercially available alumina is ALCOA.

It will be appreciated that many vendors supply multiple commercially available forms of barytes for use in the friction material 22. In the various embodiments of the present invention, one such exemplary source for suitable commercially available barytes is Cinbar Performance Minerals, Cartersville, Ga.

It will be appreciated that many vendors supply multiple commercially available forms of graphite or coke suitable for use in the friction material 22. In the various embodiments of the present invention, one such exemplary source of suitable commercially available graphite or coke is from Asbury Carbons, Inc. (Asbury, N.J.).

It will be appreciated that many vendors supply multiple commercially available aramid fibers and/or pulp suitable for use in the friction material 22. In the various embodiments of the present invention, one such exemplary source of suitable aramid fiber or pulp is DuPont (Richmond, Va.).

In one embodiment of the present invention, the binder is a phenolic resin. The components of the friction material 22 are subjected to a surface treatment with a phenolic resin. The components subjected to such a surface treatment have an advantage that they can be easily mixed with other components when the friction material 22 is manufactured. In another embodiment, a silane coupling agent can be used in lieu of the phenolic resin. Further detail as to use and substitution of the phenolic resin, the silane coupling agent or other binders, is more fully discussed in commonly assigned U.S. Pat. No. 6,670,408, issued Dec. 30, 2003, which is hereby incorporated by reference in its entirety as if fully set forth herein.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A braking element comprising:
a friction material including one of iron fibers, aluminum, zinc, tin and combinations thereof, wherein an amount of said iron fibers in said friction material is in a range between about 1 v % to about 10 v %, wherein an amount of one of said aluminum, said zinc, said tin and said combinations thereof is in a range between about 1 v % to about 5 v % and wherein said friction material is free of elemental copper.

2. The braking element of claim 1 wherein said amount of said iron fibers is about 2.5 v %.

3. The braking element of claim 1 wherein said amount of said one of said aluminum, said zinc, said tin and said combinations thereof is about 1 v %.

4. A braking element comprising:
a friction material including iron fibers, wherein an amount of said iron fibers in said friction material is in a range between about 1 v % to about 10 v % and wherein said friction material is free of copper.

5. The braking element of claim 4 wherein said friction material is free of elemental copper.

6. The braking element of claim 4, wherein said amount of said iron fibers is about 2.5 percent by volume.

7. The braking element of claim 4, wherein a length of said iron fibers is in a range between about one-quarter inch (about 0.64 mm) and about one-half inch (about 1.3 mm).

8. The braking element of claim 4, wherein a width of said iron fibers is about 20 micrometers.

9. The braking element of claim 4, wherein said friction material includes one of aluminum, zinc, tin and combinations thereof.

10. The braking element of claim 9, wherein an amount of said aluminum, said zinc, said tin and said combinations thereof is in a range between about 1 v % to about 5 v %.

11. The braking element of claim 10, wherein said amount of said aluminum, said zinc, said tin and said combinations thereof is about 1 v %.

12. The braking element of claim 9, wherein one of said aluminum, said zinc, said tin and said combinations thereof is a fiber.

13. The braking element of claim 12, wherein one of said aluminum, said zinc, said tin and said combinations thereof is said fiber, each of said fibers having a length in a range between about one-quarter inch (about 0.64 mm) and about one-half inch (about 1.3 mm).

14. The braking element of claim 12, wherein one of said aluminum, said zinc, said tin and said combinations thereof is said fiber, each of said fibers having a width in a range between about 20 micrometers and about 80 micrometers.

15. The braking element of claim 9, wherein one of said aluminum, said zinc, said tin and said combinations thereof is a powder.

16. The braking element of claim 15, wherein one of said aluminum, said zinc, said tin and said combinations thereof is said powder, each particle of said powder having a largest dimension of about 0.05 inches (about 1.5 millimeters).

17. The braking element of claim 4, wherein said amount of said iron fibers is about 4.5 v %.

18. The braking element of claim 4, wherein said amount of said iron fibers is about 1 v %.

19. The braking element of claim 4, wherein a length-to-width ratio of the iron fibers ranges between about 8 to 1 to about 65 to 1.

20. A braking element comprising:
a friction material free of elemental copper.

21. A braking element comprising:
a friction material including one of aluminum, zinc, tin and combinations thereof, wherein an amount of one of said aluminum, said zinc, said tin and said combinations thereof is about 1 v % and wherein an amount of said iron fibers in said friction material is about 2.5 v % and said friction material is free of elemental copper.
